(19) United States
(12) Patent Application Publication
(10) Pub. No.: US 2023/0280767 A1
(43) Pub. Date: Sep. 7, 2023

(54) COLLABORATIVE SEARCH MAPPING FOR AUTONOMOUS MULTI-ASSET TEAMS

(71) Applicant: Rockwell Collins, Inc., Cedar Rapids, IA (US)

(72) Inventors: Daniel K. Papke, Marion, IA (US); Jason J. Jakusz, Nixa, MO (US)

(21) Appl. No.: 17/704,715

(22) Filed: Mar. 25, 2022

Related U.S. Application Data
(63) Continuation-in-part of application No. 17/684,095, filed on Mar. 1, 2022.

(51) Int. Cl. G05D 1/10; B64C 39/02

(52) U.S. Cl. CPC G05D 1/104; G05D 1/1064; B64C 39/024; B64C 2201/143

(57) ABSTRACT

A system and method for autonomous vehicle (AV) team coordination are disclosed. An ownship AV generates ownship measurement data and a teammate AV generates teammate measurement data. A time slice of the ownship measurement data is matched to a time slice of the teammate measurement data based on a time slice index.

An area of the environment is identified as a detected area or a non-detected area based on the measurement data associated with the matched time slices. An occupancy map is populated based on the identification of the area as the detected area or the non-detected area.

### CROSS-REFERENCE TO RELATED APPLICATIONS

The present application is related to and claims the benefit of the earliest available effective filing dates from the following listed applications (the “Related Applications”) (e.g., claims earliest available priority dates for other than provisional patent applications (e.g., under 35 USC § 120 as a continuation in part) or claims benefits under 35 USC § 119(e) for provisional patent applications, for any and all parent, grandparent, great-grandparent, etc. applications of the Related Applications).

Related Applications:

U.S. patent application Ser. No. 17/684,095 filed Mar. 1, 2022 and entitled HIGH FIDELITY TEAMMATE STATE ESTIMATION FOR COORDINATED AUTONOMOUS OPERATIONS IN COMMUNICATIONS DENIED ENVIRONMENTS;

Concurrently filed U.S. patent application Ser. No. XX/XXX,XXX having attorney docket number 133232US01 and entitled AUTONOMOUS VEHICLE-BASED MISSION PLANNING AND AUTONOMY SYSTEM FOR MULTI-ASSET COLLABORATIVE OPERATIONS; and

Concurrently filed U.S. patent application Ser. No. XX/XXX,XXX having attorney docket number 133435US01 and entitled SYSTEM AND METHOD FOR GUIDANCE INTEGRITY MONITORING FOR LOW-INTEGRITY MODULES.

Said U.S. patent applications Ser. No. 17/684,095; XX/XXX,XXX (133232US01); and XX/XXX,XXX (133435US01) are herein incorporated by reference in their entirety.

### BACKGROUND

Autonomous vehicle (AV) technology is advancing rapidly in both capability and complexity. In military applications, land-based, air-based, or sea-based AVs perform tasks that are conventionally performed by human operators (e.g., surveillance, target acquisition, reconnaissance, munition strikes, etc.), reducing the risk of bodily harm to military personnel.

### SUMMARY

A mission system for AV team coordination is disclosed in accordance with one or more illustrative embodiments of the present disclosure. In one illustrative embodiment, the system comprises a plurality of controllers. Each of two or more AVs includes a respective one of the plurality of controllers. One of the two or more AVs comprises an ownship AV, and others of the two or more AVs comprise one or more teammate AVs. The ownship AV includes one or more ownship sensors configured to generate ownship measurement data of an environment surrounding the ownship AV. Each of the teammate AV(s) include one or more teammate sensors configured to generate teammate measurement data of the environment surrounding the respective teammate AV. Each of the ownship measurement data and the teammate measurement data is a time series comprising a plurality of time slices, wherein each of the plurality of time slices is associated with: a time slice index, a pose of the respective AV, and a pose of the respective sensor(s) defined in azimuth angle and elevation angle, and object detection data.

The respective one of the plurality of controllers includes one or more processors configured to execute program instructions causing the one or more processors to: store the ownship measurement data and the teammate measurement data in a memory cache; match a time slice of the ownship measurement data to a time slice of the teammate measurement data based on the time slice index; identify an area of the environment as a detected area or a non-detected area, the identification based on: the pose of the ownship AV, the pose of the ownship sensor(s), and the object detection data associated with the time slice of the ownship measurement data, and the pose of the teammate AV(s), the pose(s) of the teammate sensor(s), and the object detection data associated with the time slice of the teammate measurement data; and populate an occupancy map based on the identification of the area of the environment as the detected area or the non-detected area.

A method for AV team coordination is disclosed in accordance with one or more illustrative embodiments of the present disclosure. Each of two or more AVs includes a respective one of the plurality of controllers. One of the two or more AVs comprises an ownship AV, and others of the two or more AVs comprise one or more teammate AVs. The ownship AV includes one or more ownship sensors configured to generate ownship measurement data of an environment surrounding the ownship AV. Each of the teammate AV(s) include one or more teammate sensors configured to generate teammate measurement data of the environment surrounding the respective teammate AV. Each of the ownship measurement data and the teammate measurement data is a time series comprising a plurality of time slices, wherein each of the plurality of time slices is associated with: a time slice index, a pose of the respective AV, and a pose of the respective sensor(s) defined in azimuth angle and elevation angle, and object detection data.

In one illustrative embodiment, the method comprises storing the ownship measurement data and the teammate measurement data in a memory cache; matching a time slice of the ownship measurement data to a time slice of the teammate measurement data based on the time slice index; identifying an area of the environment as a detected area or a non-detected area, the identification based on: the pose of the ownship AV, the pose of the ownship sensor(s), and the object detection data associated with the time slice of the ownship measurement data, and the pose of the teammate AV(s), the pose(s) of the teammate sensor(s), and the object detection data associated with the time slice of the teammate measurement data; and populating an occupancy map based on the identification of the area of the environment as the detected area or the non-detected area.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1 is a schematic diagram illustrating a plurality of AVs, in accordance with one or more embodiments of the present disclosure;

FIG. 2 is schematic diagram illustrating a mission system for AV team coordination implementing a search mapping flow, in accordance with one or more embodiments of the present disclosure;

FIG. 3 is schematic diagram illustrating the mission system of FIG. 2 implementing a missing data request flow, in accordance with one or more embodiments of the present disclosure;

FIG. 4 is a conceptual diagram illustrating an identification of a non-detected area, in accordance with one or more embodiments of the present disclosure;

FIG. 5 is a conceptual diagram illustrating an identification of a detected area, in accordance with one or more embodiments of the present disclosure; and

FIG. 6 is a flowchart illustrating a method for AV team coordination, in accordance with one or more embodiments of the present disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the present disclosure, numerous specific details are set forth in order to provide a more thorough understanding of the inventive concepts. However, it will be apparent to one of ordinary skill in the art having the benefit of the present disclosure that the inventive concepts disclosed herein may be practiced without these specific details. In other instances, well-known features may not be described in detail to avoid unnecessarily complicating the present disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). In addition, use of the “a” or “an” are employed to describe elements and components of embodiments of the present inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features which may not necessarily be expressly described or inherently present in the present disclosure.

AV search operations (e.g., performed by a team of two or more AVs) entail using sensors, cameras, and/or detectors to detect and identify objects in environments surrounding the AVs. The objects can include threats, terrain, obstacles, or weather in the area searched by the team of AVs. The search data generated by the search operations can be displayed in a map.

AV search operations require a method to distill data into a progress assessment (i.e., which part of an area has been searched?). In addition, independent AVs engaged in cooperative searches must exchange search data with other AVs.

Since communication scales exponentially when every AV communicates directly, search data exchange becomes increasingly difficult with multiple AVs. Furthermore, arbitration can be required to produce a synchronized view of the world. Arbitration entails a need for voting between AVs to reach a shared view of the world (e.g., where some search results may be prioritized over other search results based on a comparison of quality, accuracy, reliability, redundancy, etc.)

Embodiments of the present disclosure are directed to a mission system for AV team coordination, and a method of using the same. The present system and method enable a team of AVs to distill, store, and exchange search data with each other. The present system and method include a mechanism to “catch up” and transmit missing data after a period during which the AVs are communication-denied.

The present system and method entail the exchange of discrete measurement data (derived from sensors) between AVs, rather than map data (e.g., image data or pixel data). The discrete measurement data, received from another AV, is used to deduce or construct a map (synchronized search map or occupancy map) at the receiving AV.

Additionally, the present system and method entails the caching of discrete measurement data for retransmission when assets regain communication.

Further, the present system and method may correlate (using, e.g., common GPS time between or among AVs) measurement data from discrete AV measurements into AV groupings to deduce search data. In this way, the team of AVs maintains a synchronized search map (e.g., occupancy map) without the need to synchronize the map data itself, or requiring a centralized leader to coordinate.

The embodiments of the disclosure are not obvious and provide several advantages. The present system and method are effective even over low-bandwidth data-links. Each AV may function independently, enabling temporary segmentation of a team during communication denial, while also enabling efficient exchange of search data when communication is available. The present system and method eliminate the requirement for arbitration (i.e., voting) between AVs to reach a shared view of the world.

The present system and method are advantageous when deployed using AV embedded systems since memory space may be highly constrained (e.g., to a few dozen MB). Therefore, the present system and method are particularly advantageous when, for example, measurement data from sensors is smaller than derived map data (image data or pixel data).

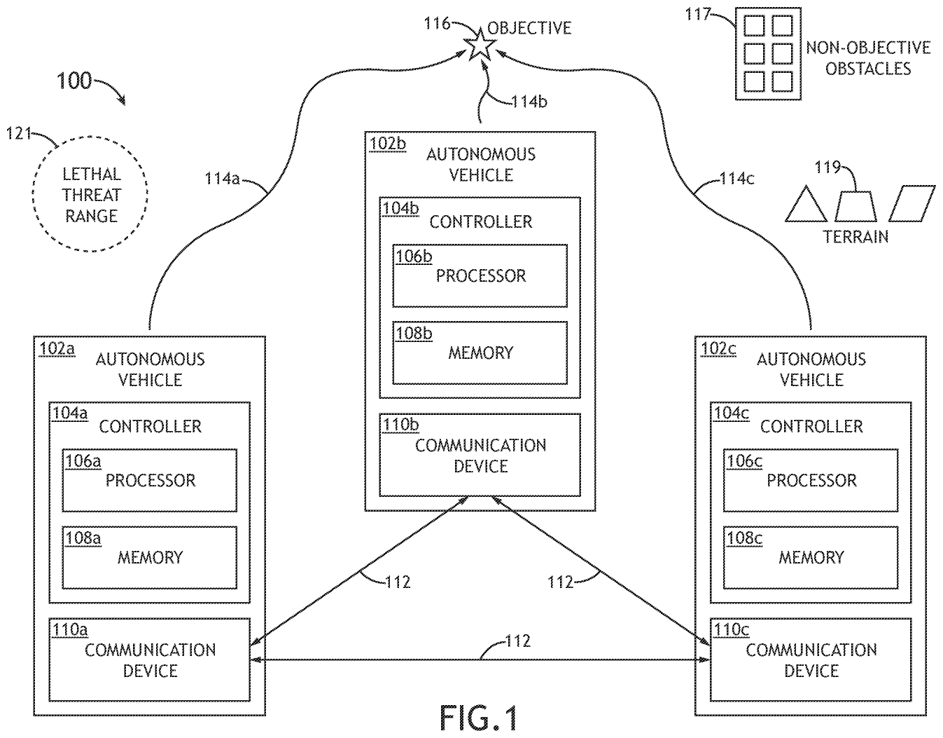

FIG. 1 is a schematic diagram illustrating a mission system 100 for AV team coordination, in accordance with one or more embodiments of the present disclosure. The mission system 100 comprises a team of AVs 102a-c. Each of the AVs 102a-c includes a respective controller 104a-c (e.g., computers or computing devices), one or more processors 106a-c, a memory 108a-c, and a communication device 110a-c. Although only three AVs 102a-c are shown in FIG. 1, it is contemplated that team of AVs 102a-c may comprise any number of AVs 102a-c (for example, 50 AVs, 100 AVs, etc.).

The AVs 102a-c may comprise aerial, land, or sea vehicles. For example, the AVs 102a-c may comprise one or more unmanned aerial vehicles (UAVs) or drones. The AVs 102a-c may perform one or more mission tasks. For example, the AVs 102a-c may travel to a location of a shared objective 116 via navigation trajectories 114a-c, and perform additional mission tasks at the location of the shared objective 116. The AVs 102a-c may encounter obstacles 117 (buildings, towers, bridges, dams, etc.), terrain 119 (mountains, hills, canyons, valleys, rocks, etc.), adversarial threats 121 (e.g., military structures, vehicles weapons, etc.), or weather (e.g., thunderstorms, hurricanes, fog, ice, snow, rain, winds, etc.),

In some embodiments, a user (one or more pilots) of the team of AVs 102a-c may utilize a ground station controller (not shown) communicatively coupled (via a direct radio link or satellite link) to the AVs 102a-c. The user may be physically remote from the AVs 102a-c, and may interface with the AVs 102a-c using input devices such as keyboards and joysticks, and output devices such as monitors.

Each of the controllers 104a-c may be communicatively coupled to a respective communication device 110a-c, such that each controller 104a-c transmits and receives data via the respective communication device 110a-c. The communication device 110a-c may comprise one or more antennas, including an RF front end, transmitter/receiver, and radiating elements, and may communicate in the RF frequency range. Thus, the mission data may be shared between the AVs 102a-c using the communication devices 110a-c.

It is noted herein that, for the purposes of the present disclosure, the term “processor” or “processing element” may be broadly defined to encompass any device having one or more processing or logic elements, for example, one or more central processing units (CPUs), one or more graphics processing units (GPUs), one or more micro-processor devices, one or more application specific integrated circuit (ASIC) devices, one or more field programmable gate arrays (FPGAs), or one or more digital signal processors (DSPs). In this sense, the one or more processors 106a-c may include any device configured to execute algorithms and/or instructions (e.g., program instructions stored in memory), and may be configured to perform method steps described in the present disclosure. The memory 108a-c may include any storage medium known in the art suitable for storing program instructions executable by the associated one or more processors. For example, the storage medium may include, but is not limited to, a read-only memory (ROM), a random-access memory (RAM), a magnetic or optical memory device (e.g., hard disk), a magnetic tape, a solid-state drive, and the like.

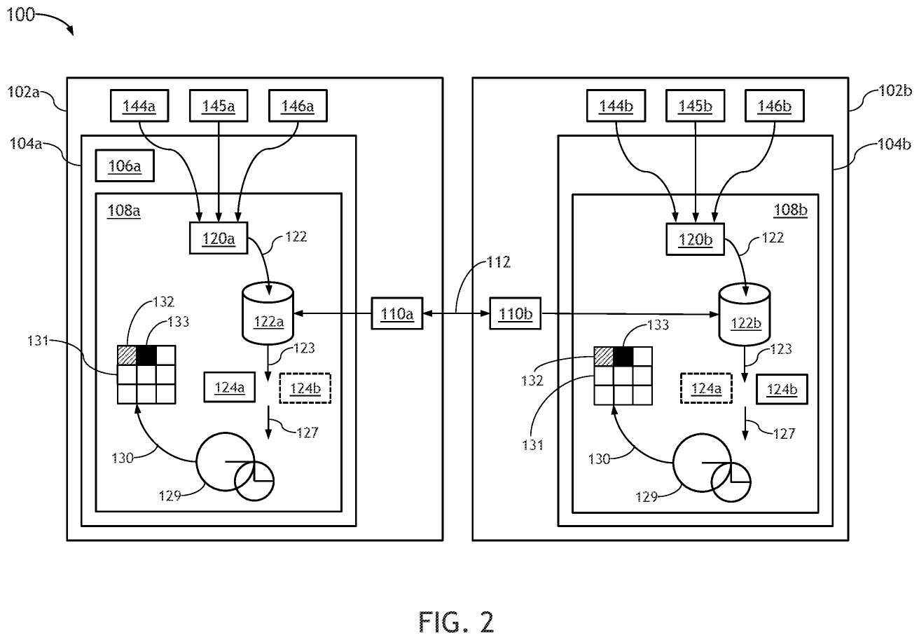

FIG. 2 is a schematic diagram illustrating a mission system 100 including the controllers 104a-b, in accordance with one or more embodiments of the present disclosure. Each of the AVs 102a-b may include a respective one of the controllers 104a-b. A search mapping data flow is implemented by the system 100 during communication availability.

It is noted herein that the AV 102a may be construed as an “ownship AV,” and the AVs 102b may be construed as a “teammate AV.” However, it is noted herein that any particular one the AVs 102 may be construed as an “ownship AV,” and that the others of the AVs 102 (that are not said particular one of the AVs) may be construed as a “teammate AV.”

Each of the AVs 102a-b may respectively include an EO/IR imaging sensor 144a-b, a radar imaging sensor 145a-b, and/or a passive RF sensor 146a-b. The imaging EO/IR sensor 144a-b may be a charge-coupled device (CCD) or CMOS device, may operate in the visual or IR spectral range, and may be configured to generate images of the environment. The radar imaging sensor 145a-b may transmit signals (e.g., pulses of signals in the RF spectral range), receive reflected return signals, and generate images based on the return signals. The passive RF sensor 146a-b may detect passive radiation (e.g., black-body radiation) and the characteristics of those emissions may be used to geolocate and identify threats (i.e., without imagery). The combination of imaging sensors 144a-b, 145a-b, and 146a-b may advantageously provide a redundant system for detecting objects (in case one or more of the sensors stops functioning).

The EO/IR imaging sensors 144a-b, the radar imaging sensors 145a-b, and/or passive RF sensors 146a-b may generate measurement data 120. The sensors 144a, 145a, and/or 146a may generate ownship measurement data (i.e., corresponding to the ownship AV 102a). The sensors 144b, 145b, and 146b may generate teammate measurement data (i.e., corresponding to the teammate AV(s) 102b).

It is noted that the expression “ownship measurement data” and the expression “teammate measurement data” are used for explanatory purposes, and that any particular one of the AVs 102 may be construed as an “ownship AV” and generate “ownship measurement data,” while the other(s) of the AVs 102 may be construed as “teammate AV(s)” and generate “teammate measurement data”.

The measurement data may be stored 122 in a respective memory cache 122a-b (e.g., part of the memory 108 of the respective AV 102). The memory cache 122a-b may be configured for the low latency transfer (i.e., creation, reading, updating, deleting) of the measurement data 120, and may provide a lower latency transfer of the measurement data 120 than provided otherwise by a random-access memory of the respective memory 108.

The measurement data 120 may be transferred between cache 122a and cache 122b, and vice versa. The data 120 may be shared using respective communication devices 110a-b. The communication device 110a may communicate with the communication device 110b via RF signals 112 (communicating in the RF signal range).

Each of the ownship measurement data 120a and the teammate measurement data 120b may be a time series (i.e., a sequence of data points occurring in successive order over time). Accordingly, each of the ownship measurement data 120a and the teammate data 120b may comprise a plurality of time slices. Each time slice may be a sequence (a list, array, an object, a dictionary, a hashmap, etc.) having a plurality of values. Each time slice may be associated with a time slice index to differentiate between the plurality of time slices (for example, the index of a list or array).

In some embodiments, each time slice may respectively include data related to a pose of the respective AV 102 defined in latitude, longitude, and heading. In some embodiments, the pose of the respective AV 102 may further be defined in azimuth angle (horizontal angle) and elevation angle (e.g., vertical angle or attitude). In some embodiments, each time slice may respectively include data related to a pose of the respective sensor(s) 144, 145, and 146 defined in azimuth angle and elevation angle.

In some embodiments, each time slice may respectively include object detection data. The object detection data may be a sequence (e.g., a list), where each value of the sequence corresponds to an identification of an area of the environment as a detected area or a non-detected area. Additionally or alternatively, in some embodiments, each value of the sequence may include object name data (e.g., “Building 1”; “Adversarial Threat 2”; “Thunderstorm Cell 1”, etc.), object type data (e.g., structure, terrain, vehicle, weapon, etc.),

In this way, each AV 102 in the system 100 may capture a snapshot of “world state” (i.e., discrete time slice) at regular intervals of time. This time slice of the world state may be broadcast to other AVs 102 on the team. Each AV 102 collects time slices from other teammate AVs 102. When sufficient sets of time slices are received (where every time slice in the respective set corresponds to the same time slice index), the respective AV 102 evaluates correlated time slices for deducible search information (e.g., presence/absence of objects or search targets). Correlated snapshots are continuously received and evaluated for deducible search information in real-time.

Each AV 102 may process the time slices in temporal order, and track a most recent time slice received from another teammate AV 102. If a discontinuity is detected, the AV 102 may send a missing data request for the missing time slice(s). The missing data request may enable the acquisition of any data that is previously acquired by a teammate AV for the duration of communication denial. Missing data requests may be bounded in size to limit burst data over a radio link (e.g., RF signals 112).

As shown in FIG. 2, a time slice 124a stored in cache 122a and associated with the data 120a may be correlated 123 to a time slice 124b stored in cache 122b and associated with the data 120b. The correlation 123 may be based on the time slice index (e.g., index=0, 1, 2, etc.). Each time slice 124a and 124b may represent data collected during the same duration of time by each AV 102a-b. The duration of time, T_{slice}, may be, for example, 10 milliseconds, 100 milliseconds, 1 second, etc.

Each controller 104 may be synchronized to the same clock (e.g., on-board or remote time server, atomic clock, etc.), which in some embodiments may be a GPS-based clock. The duration of time T_{slice} may be modifiable before a compile-time of a program implementing the present system and method. In some embodiments, the duration of time T_{slice} may be modifiable at run-time of a program implementing the present system and method.

Using the time slices 124a and 124b, one or more areas 129 of the environment surrounding the AVs 102 may be identified 127 as a detected area 133 or a non-detected area 132. The identification 127 may be a deduction based on (A) the pose of the ownship AV 102a, the pose of the ownship sensor(s) 144a, 145a, 146a, and the object detection data associated with the time slice 124a, and (B) the pose of the teammate AV(s) 102b, the pose(s) of the teammate sensor(s) 144b, 145b, 146b, and the object detection data associated with the time slice 124b.

In some embodiments, in response to the object detection data associated with the time slice 124a and the object detection data associated with the time slice 124b both indicating a presence of an object, an area 129 may be identified as a detected area 133.

In some embodiments, in response to the object detection data associated with the time slice 124a and the object detection data associated with the time slice 124b both indicating an absence of an object (zero or no object), an area 129 may be identified as a non-detected area 132.

The identified detected areas 133 and non-detected areas 132 may then be used to populate (i.e., project) 130 an occupancy map 131 (i.e., mission map) comprising a plurality of map cells. The occupancy map 131 may be a three-dimensional (3D) map comprising a plurality of voxels, or a two-dimensional (2D) map comprising a plurality of pixels. In one embodiment, the occupancy map 131 is a 2D map to conserve memory space. In some embodiments, the occupancy map 131 comprises an octree structure.

The occupancy map 131 may include detection data associated with objects in the environment of the AV 102 (e.g., type of object, GPS coordinates of object, etc.). The occupancy map 131 may be populated independently by each AV 102, and the end result may be the same occupancy map 131. Given that the input data is the same, each AV 102 produces an equivalent occupancy map 131. This parallel deduction avoids the arbitration problem which may arise when derived inputs are shared rather than discrete inputs, and may also conserve memory and processing resources.

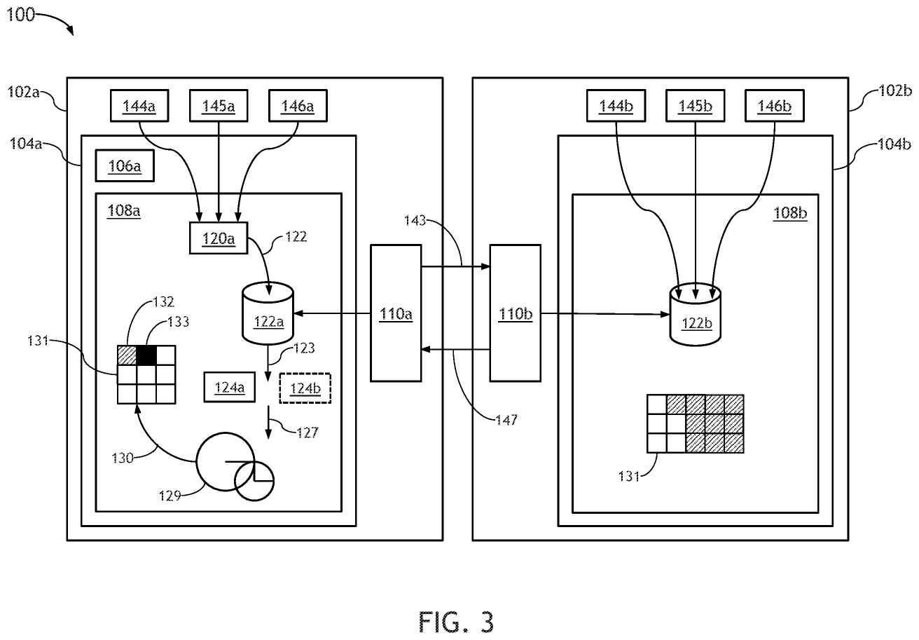

FIG. 3 is a schematic diagram illustrating the mission system 100 of FIG. 2 implementing a missing data request flow, in accordance with one or more embodiments of the present disclosure.

After a duration of communication denial, a missing data request 143 may be transmitted from the ownship AV 102a to the teammate AV(s) 102b, and a missing data response 147 including teammate measurement data 120b generated during the duration of the communication denial (stored in cache 122b) is transmitted from the teammate AV(s) 102b to the ownship AV 102a. The missing data request 143 and the missing data response 147 may be transmitted using a respective communication device 110a-b on the ownship AV 102a and the teammate AV(s) 102b.

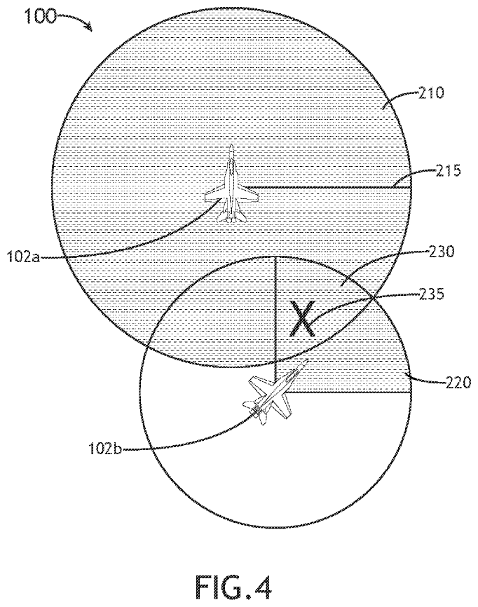

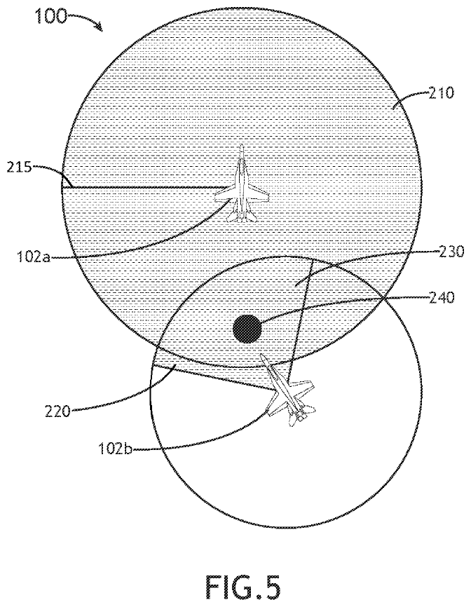

FIGS. 4 and 5 are conceptual diagrams respectively illustrating an identification of a non-detected area and a detected area, in accordance with one or more embodiments of the present disclosure.

As shown in FIG. 4, the ownship AV 102a may “listen” (e.g., passively detect via onboard sensors 144a, 145a, 146a) throughout its average effective range, e.g., through an omnidirectional detection area 210 (e.g., the detection area corresponding to a 2D circular area or a 3D spherical volume as determined by available sensor geometries) corresponding to an effective range 215, for emissions generated via the teammate AV 102b. For example, the teammate AV 102b may emit a directional beam 220 (e.g., a 90° elicit beam) defined in a beam width from 10° to 180°, for example, 90° (“pie slice” shape). In FIG. 4, the overlapping area 230 is identified as a non-detect area 235 in response to both the lack of targets detected by the ownship AV 102a within its omnidirectional detection area 210 and the active elicit beam 220 indicating an absence of targets. As shown in FIG. 5, the overlapping area 230 is identified as a detect area 240 in response to target detections by the AV 102a within the overlapping portion of the omnidirectional detection area 210 and the active elicit beam 220 indicating the presence of targets. In some embodiments, either of the ownship AV 102a or the teammate AV 102b may both elicit (e.g., via elicit beam 220) and detect (e.g., via passive sensors 144a-b, 145a-b, 146a-b), or detect targets without the need for elicitation.

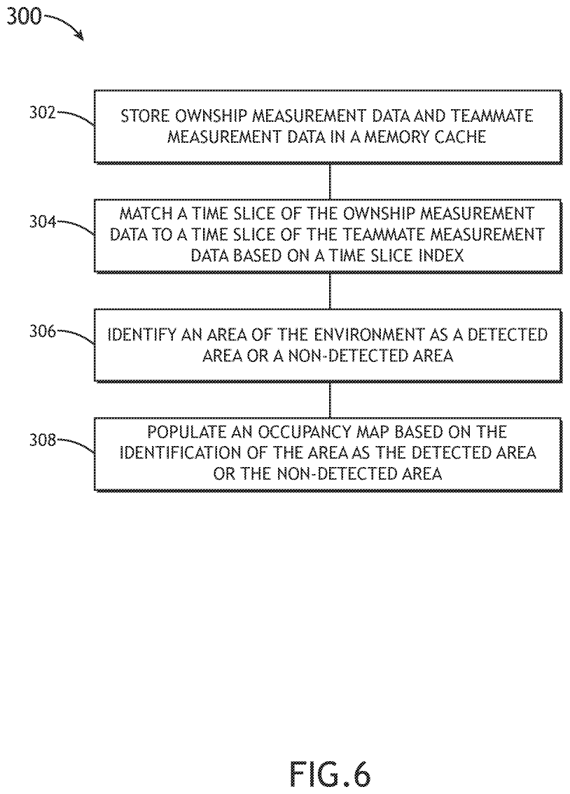

FIG. 6 is a flowchart illustrating a method 300 for AV team coordination, in accordance with one or more embodiments of the present disclosure. The present method 300 may be a method of using the mission system 100 described with respect to FIGS. 2-5.

At 302, ownship measurement data and teammate measurement data are stored in a memory cache.

At 304, a time slice of the ownship measurement data is matched to a time slice of the teammate measurement data based on a time slice index.

At 306, an area of the environment is identified as a detected area or a non-detected area.

At 308. an occupancy map is populated based on the identification of the area as the detected area or the non-detected area.

The present system and method significantly improve mission effectiveness and continuity throughout communications outages, and may be especially advantageous in situations where numerous aerial AVs are operating in a dense urban environment.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

We claim:

1. A mission system for autonomous vehicle (AV) team coordination, comprising:
a plurality of controllers,
wherein each of two or more AVs includes a respective one of the plurality of controllers,
wherein one of the two or more AVs comprises an ownship AV, and others of the two or more AVs comprise one or more teammate AVs,
wherein the ownship AV includes one or more ownship sensors configured to generate ownship measurement data of an environment surrounding the ownship AV,
wherein each of the teammate AV(s) include one or more teammate sensors configured to generate teammate measurement data of the environment surrounding the respective teammate AV,
wherein each of the ownship measurement data and the teammate measurement data is a time series comprising a plurality of time slices, wherein each of the plurality of time slices is associated with:
a time slice index to differentiate between the plurality of time slices, and
a pose of the respective AV defined in latitude, longitude and heading,
a pose of the respective sensor(s) defined in azimuth angle and elevation angle,
and
object detection data,
wherein the respective one of the plurality of controllers associated with the ownship AV includes one or more processors configured to execute program instructions causing the one or more processors to:
store the ownship measurement data and the teammate measurement data in a memory cache;
match a time slice of the ownship measurement data to a time slice of the teammate measurement data based on the time slice index;
identify an area of the environment as a detected area or a non-detected area, the identification based on:
the pose of the ownship AV, the pose of the ownship sensor(s), and the object detection data associated with the time slice of the ownship measurement data,
and
the pose of the teammate AV(s), the pose(s) of the teammate sensor(s), and the object detection data associated with the time slice of the teammate measurement data;
and
populate an occupancy map based on the identification of the area of the environment as the detected area or the non-detected area.

2. The system of claim 1, wherein the area of the environment is identified as the detected area responsive to:
(i) the object detection data associated with the time slice of the ownship measurement data and (ii) the object detection data associated with the time slice of the teammate measurement data both indicating a presence of an object.

3. The system of claim 2, wherein the object includes at least one of:
terrain,
an obstacle;
or
an adversarial threat.

4. The system of claim 1, wherein the area of the environment is identified as the non-detected area responsive to:
(i) the object detection data associated with the time slice of the ownship measurement data and (ii) the object detection data associated with the time slice of the teammate measurement data both indicating an absence of an object.

5. The system of claim 4, wherein the object includes at least one of:
terrain,
an obstacle;
or
an adversarial threat.

6. The system of claim 1, wherein, for a duration of communication availability, the ownship measurement data and the teammate measurement data are shared between the ownship AV and the teammate AV(s) using a respective communication device of the ownship AV and the teammate AV(s).

7. The system of claim 1, wherein, after a duration of communication denial, a missing data request is transmitted from the ownship AV to the teammate AV(s), and a missing data response including the teammate measurement data generated during the duration of the communication denial is received from the teammate AV(s) by the ownship AV,
wherein the missing data request and the missing data response are transmitted using a respective communication device of the ownship AV and the teammate AV(s).

8. The system of claim 1, wherein at least one of the ownship sensor(s) is associated with an effective range for passive detection.

9. The system of claim 1, wherein at least one of the ownship sensor(s) is configured to emit a directional RF beam defined in a beam width.

10. The system of claim 9, wherein the beam width is of from 10° to 180°.

11. A method for autonomous vehicle (AV) team coordination,
wherein each of two or more AVs includes a respective one of a plurality of controllers,
wherein one of the two or more AVs comprises an ownship AV, and others of the two or more AVs comprise one or more teammate AVs,
wherein the ownship AV includes one or more ownship sensors configured to generate ownship measurement data of an environment surrounding the ownship AV,
wherein each of the teammate AV(s) include one or more teammate sensors configured to generate teammate measurement data of the environment surrounding the respective teammate AV,
wherein each of the ownship measurement data and the teammate measurement data is a time series comprising a plurality of time slices, wherein each of the plurality of time slices is associated with:
a time slice index to differentiate between the plurality of time slices, and
a pose of the respective AV defined in latitude, longitude and heading,
a pose of the respective sensor(s) defined in azimuth angle and elevation angle,
and
object detection data,
wherein the method comprises:
storing the ownship measurement data and the teammate measurement data in a memory cache of the ownship AV;
matching, via a controller of the ownship AV, a time slice of the ownship measurement data to a time slice of the teammate measurement data based on the time slice index;
identifying, via the controller, an area of the environment as a detected area or a non-detected area, the identification based on:
the pose of the ownship AV, the pose of the ownship sensor(s), and the object detection data associated with the time slice of the ownship measurement data,
and
the pose of the teammate AV(s), the pose(s) of the teammate sensor(s), and the object detection data associated with the time slice of the teammate measurement data;
and
populating, via the controller, an occupancy map based on the identification of the area of the environment as the detected area or the non-detected area.

12. The method of claim 11, wherein the area of the environment is identified as the detected area responsive to:
(i) the object detection data associated with the time slice of the ownship measurement data and (ii) the object detection data associated with the time slice of the teammate measurement data both indicating a presence of an object.

13. The method of claim 12, wherein the object includes at least one of:
terrain,
an obstacle;
or
an adversarial threat.

14. The method of claim 11, wherein the area of the environment is identified as the non-detected area responsive to:
(i) the object detection data associated with the time slice of the ownship measurement data and (ii) the object detection data associated with the time slice of the teammate measurement data both indicating an absence of an object.

15. The method of claim 14, wherein the object includes at least one of:
terrain,
an obstacle;
or
an adversarial threat.

16. The method of claim 11, wherein, for a duration of communication availability, the ownship measurement data and the teammate measurement data are shared between the ownship AV and the teammate AV(s).

17. The method of claim 11, wherein, after a duration of communication denial, a missing data request is transmitted from the ownship AV to the teammate AV(s), and a missing data response including the teammate measurement data generated during the duration of the communication denial is received from the teammate AV(s) by the ownship AV,
wherein the missing data request and the missing data response are transmitted using a respective communication device of the ownship AV and the teammate AV(s).

18. The method of claim 11, wherein at least one of the ownship sensor(s) or the teammate sensor(s) is associated with an effective range for passive detection.

19. The method of claim 11, wherein at least one of the ownship sensor(s) is configured to emit a directional RF beam defined in a beam width.

20. The method of claim 19, wherein the beam width is of from 10° to 180°.
